(19) United States
(12) Patent Application Publication
(10) Pub. No.: US 2005/0231636 A1
(43) Pub. Date: Oct. 20, 2005

(54) Equal-interval vertical image conversion method and apparatus for converting CIF image into NTSC image

(75) Inventor: Joo Hyung Kim, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 11/073,482

(22) Filed: Mar. 4, 2005

(30) Foreign Application Priority Data
Apr. 6, 2004 (KR) 2004-23536

(51) Int. Cl. H04N 11/20

(52) U.S. Cl. 348/441

(57) ABSTRACT

Disclosed are an equal-interval vertical image conversion method and apparatus for converting a CIF (Common Intermediate Format) image into an NTSC (National Television Standards Committee) image. At least one input line (Y(n)) is stored in a line buffer. At least one output line (Y(b)) is read from the line buffer. Coefficients to be applied to the at least one input line (Y(n)) and the at least one output line (Y(b)) are extracted from a weight coefficient set. At least one filtered line (F(n)) is produced by a filtering operation for applying the extracted coefficients to the at least one input line (Y(n)) and the at least one output line (Y(b)). At least one new line (X(m)) is outputted by multiplexing the at least one input line (Y(n)) and the at least one filtered line (F(n)).

### BACKGROUND OF THE INVENTION

1. Field of the Invention

The present invention relates generally to an equal-interval vertical image conversion method and apparatus for converting a CIF (Common Intermediate Format) image into an NTSC (National Television Standards Committee) image, and more particularly to an equal-interval vertical image conversion method and apparatus for converting, into an NTSC image, a CIF image available in a circuit implementing a digital image data compression/decompression (or encoding/decoding) standard such as MPEG (Moving Picture Experts Group)-1, MPEG-2, MPEG-4, H.261, or H.263.

2. Description of the Related Art

Because countries use different TV (Television) systems, ITU-T (International Telecommunications Union-Telecommunication sector) prescribes CIF (Common Intermediate Format) that can be internationally and commonly used.

A CIF image (of 352×288 pixels) is mainly used in video communication at a low bit rate such as in a videophone or video conferencing. A videophone system allows calling and called parties to perform communication while looking at each other through a screen. A video conferencing system can have the effect as if the conference is held at the same time in the same place, by using multimedia data such as video, audio, text, graphics, and images anytime and anywhere.

As compression rates of video data have recently increased with the development of communication network and video compression technology, video data can be sent through a communication channel. As a video system is miniaturized with the development of semiconductor technology, mobile and personal video systems are supplied. In particular, with supply of PCs (Personal Computers) and LANs (Local Area Networks), a video system has developed into a personal system rather than a public system.

A CIF image for use in a videophone or video conferencing is originally an image standardized appropriately to a PAL (Phase Alternation by Line) display rather than an NTSC (National Television Standards Committee) display. When the CIF image is displayed on the NTSC display, 48 (=288−240) lines are not viewed on a screen. In order for the CIF image (of 352×288 pixels) to be converted into an NTSC image (of 720×240 pixels), the number of lines of video data must be converted first.

FIG. 1 is a block diagram illustrating a conventional vertical image conversion circuit for converting 288 lines of the CIF image (of 352×288 pixels) into 240 lines of the NTSC image (of 720×240 pixels). As illustrated in FIG. 1, the conventional vertical image conversion circuit includes a counter 2 for controlling a multiplexer 8, a line buffer 4 for storing previous input lines Y(n-1) (where n=1, 2, 3, . . . 288), a vertical filter 6 for generating a filter output F(n) in response to a current input line Y(n) and a previous input line Y(n-1), and the multiplexer 8 for outputting a new line X(m) (where m=1, 2, 3, . . . , 240) by multiplexing the current input line Y(n) and the filter output F(n).

FIG. 2 is a schematic diagram illustrating the vertical filter 6 shown in FIG. 1. FIG. 2 illustrates a concept of assigning weight coefficients to the current input line Y(n) and the previous input line Y(n-1) and generating the filter output F(n). As illustrated in FIG. 2, the vertical filter 6 includes a coefficient set 10 for storing the weight coefficients, a multiplier 12 for multiplying the previous input line Y(n-1) serving as an output of the line buffer 4 (shown in FIG. 1) by a weight coefficient α, a multiplier 14 for multiplying the current input line Y(n) by a weight coefficient 1-α, and an adder 16 for generating the filter output F(n) by summing an output of the multiplier 12 and an output of the multiplier 14.

FIG. 3 illustrates a process for converting 288 vertical lines of the CIF image into 240 vertical lines of the NTSC image. Referring to FIG. 3, because the number of input lines is 288 and the number of output lines is 240, a vertical scaling ratio is 240/288=5/6. That is, 6 input lines needs to be converted into 5 output lines.

When a conversion operation is repeated 48 times every 6 lines because the number of lines of the CIF video data is 288, 240 output lines can be obtained from 288 input lines.

Output Lines 2, 3 and 4 are produced by multiplications of weight coefficients taking into account spatial distances with corresponding input lines, respectively.

Output Line 1 equal to Input Line 1 is outputted.

Output Line 2 is produced when spatial distances associated with Input Lines 2 and 3 are calculated and a vertical filtering value is outputted.

Output Lines 3 and 4 are produced in the same way that Output Line 2 is outputted.

Output Line 5 equal to Input Line 6 is outputted.

As described above, 288 lines consecutively inputted can be converted using the single line buffer.

However, because a spatial distance B between Output Lines 5 and 6 is different from a spatial distance A between other output lines, a staircase effect occurs as shown in FIG. 4. Consequently, a high-quality image cannot be obtained.

Because a spatial distance between Output Lines 5k and 5k+1 (where k=1, 2, 3, . . . , 48) newly generated is different from a spatial distance between other output lines, the conventional vertical image conversion method cannot obtain a high-quality image due to the staircase effect in a vertical line direction of an image. Because input lines are stored in the line buffer at all times, power cannot be efficiently used.

### SUMMARY OF THE INVENTION

Therefore, the present invention has been made in view of the above and other problems, and it is an object of the present invention to provide an equal-interval vertical image conversion method for converting, into an NTSC (National Television Standards Committee) image, a CIF (Common Intermediate Format) image available in a circuit implementing a digital image data compression/decompression (or encoding/decoding) standard such as MPEG (Moving Picture Experts Group)-1, MPEG-2, MPEG-4, H.261, or H.263.

It is another object of the present invention to provide an equal-interval vertical image conversion apparatus for converting a CIF (Common Intermediate Format) image into an NTSC (National Television Standards Committee) image that can reduce CPU (Central Processing Unit) load by implementing hardware available in a circuit for the digital image data compression/decompression (or encoding/decoding) standard such as MPEG (Moving Picture Experts Group)-1, MPEG-2, MPEG-4, H.261, or H.263.

In accordance with an aspect of the present invention, the above and other objects can be accomplished by an equal-interval vertical image conversion method for converting a CIF (Common Intermediate Format) image into an NTSC (National Television Standards Committee) image, comprising: storing at least one input line (Y(n)) in a line buffer; reading at least one output line (Y(b)) from the line buffer; extracting coefficients to be applied to the at least one input line (Y(n)) and the at least one output line (Y(b)) from a weight coefficient set; producing at least one filtered line (F(n)) by means of a filtering operation for applying the extracted coefficients to the at least one input line (Y(n)) and the at least one output line (Y(b)); and outputting at least one new line (X(m)) by multiplexing the at least one input line (Y(n)) and the at least one filtered line (F(n)).

Preferably, the at least one input line (Y(n)) is selectively stored in the line buffer and the at least one output line (Y(b)) is selectively read from the line buffer.

Preferably, 5 new lines (X(m)) are generated from 6 input lines (Y(n)).

Preferably, ratios of weight coefficients by which the at least one input line (Y(n)) and the at least one output line (Y(b)) are multiplied are {1:0, 4/5:1/5, 3/5:2/5, 2/5:3/5, 1/5:4/5} in the weight coefficient set.

In accordance with another aspect of the present invention, the above and other objects can be accomplished by an equal-interval vertical image conversion apparatus for converting a CIF (Common Intermediate Format) image into an NTSC (National Television Standards Committee) image, comprising: line buffer controllers provided before and after a line buffer for controlling read and write operations of the line buffer; the line buffer arranged between the line buffer controllers for storing at least one selected input line (Y(b-1)) of at least one input line (Y(n)) in response to a read and write control signal (C1); a coefficient set for storing weight coefficients by which the at least one input line (Y(n)) and at least one line buffer output line (Y(b)) are multiplied; a vertical filter for generating at least one filtered line (F(n)) from the at least one input line (Y(n)) and the at least one line buffer output line (Y(b)); a multiplexer for outputting at least one new line X(m) by multiplexing the at least one input line (Y(n)) and the at least one filtered line (F(n)); and a controller for outputting the write and read control signal (C1) to the line buffer controllers, outputting a control signal (C2) for selecting the weight coefficients by which the at least one input line (Y(n)) and the at least one line buffer output line (Y(b)) are multiplexed, and outputting a control signal (C3) for controlling the multiplexer.

Preferably, the vertical filter comprises: multipliers for multiplying the at least one input line (Y(n)) and the at least one line buffer output line (Y(b)) by the weight coefficients; and an adder for summing outputs of the multipliers to generate the at least one filtered line (F(n)).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional apparatus for converting a CIF (Common Intermediate Format) image into an NTSC (National Television Standards Committee) image;

FIG. 2 is a schematic diagram illustrating a vertical filter shown in FIG. 1;

FIG. 3 is a conceptual diagram illustrating a conventional process for converting 6 input lines into 5 output lines;

FIG. 4 illustrates the staircase effect when an image is converted;

FIG. 5 is a schematic diagram illustrating an equal-interval vertical image conversion circuit for converting a CIF (Common Intermediate Format) image into an NTSC (National Television Standards Committee) image in accordance with an embodiment of the present invention;

FIG. 6 illustrates state machines of a controller and a read/write operation of a line buffer according to a state in accordance with the present invention;

FIG. 7 is a conceptual diagram illustrating a process for converting 6 input lines into 5 output lines using equal-interval vertical image conversion in accordance with the present invention; and

FIG. 8 illustrates a result of the equal-interval vertical image conversion equal to a result of ideal image conversion.

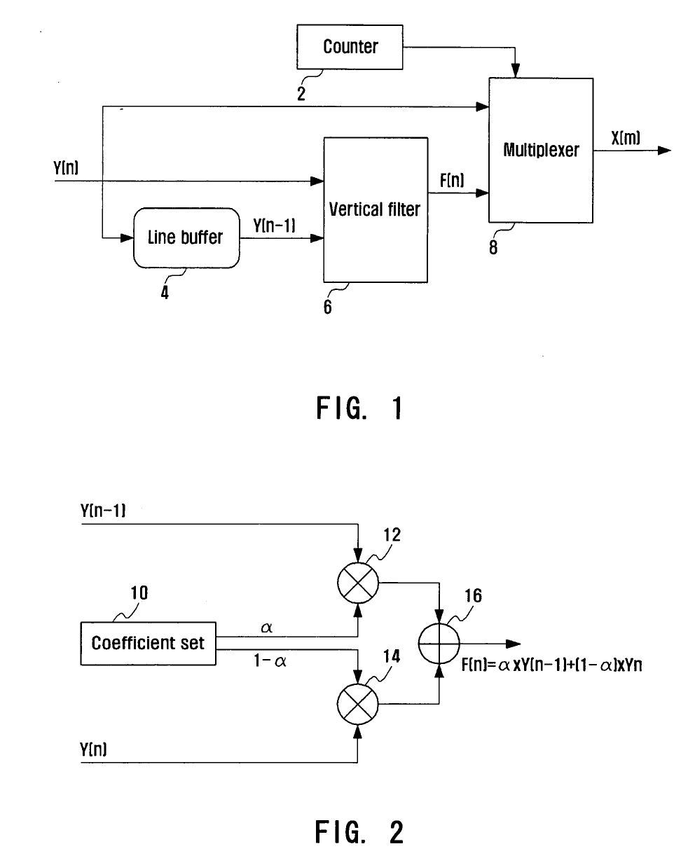

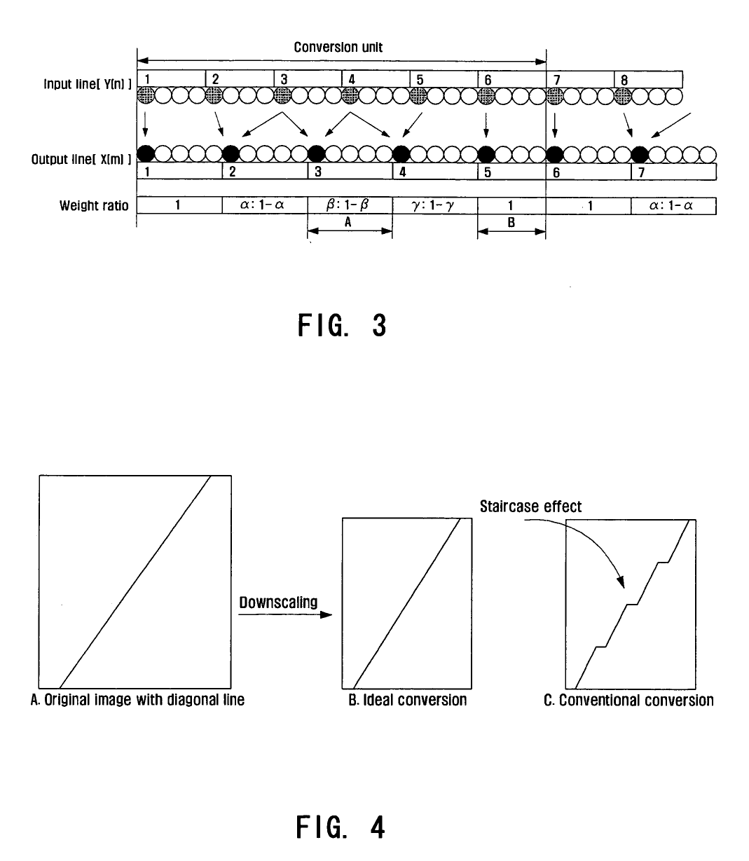

### DESCRIPTION OF THE PREFERRED EMBODIMENTS

Preferred embodiments of the present invention will be described in detail herein below with reference to the annexed drawings.

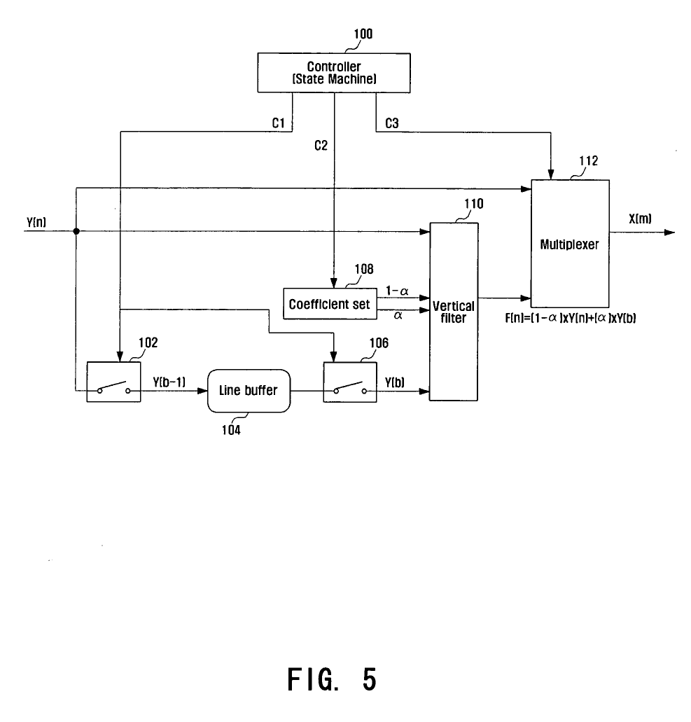

FIG. 5 is a schematic diagram illustrating an equal-interval vertical image conversion circuit for converting 288 lines of a CIF (Common Intermediate Format) image into 240 lines of an NTSC (National Television Standards Committee) image in accordance with an embodiment of the present invention. As shown in FIG. 5, the equal-interval vertical image conversion circuit includes a controller 100, line buffer controllers 102 and 106, a line buffer 104, a coefficient set 108, a vertical filter 110, and a multiplexer 112. The controller 100 controls the multiplexer 112, the line buffer 104, and the coefficient set 108. The line buffer controllers 102 and 106 control a write/read operation of the line buffer 104 before and after the line buffer 104. The line buffer 104 stores an input line Y(b-1) (where b=1, 2, 3, . . . , 192) selected by a control signal C1 among input lines Y(n) (where n=1, 2, 3, . . . , 288). The coefficient set 108 stores weight coefficients by which an input line Y(n) and a line buffer output line Y(b) are multiplied. The vertical filter 110 generates a filtered line F(n) in response to the input line Y(n) and the line buffer output line Y(b). The multiplexer 112 outputs a new line X(m) (where m=1, 2, 3, . . . , 240) by multiplexing the current input line Y(n) and the filtered line F(n).

The vertical filter 110 is a conventional filter consisting of multipliers and an adder. That is, the vertical filter 110 can be the conventional filter 6 shown in FIG. 2.

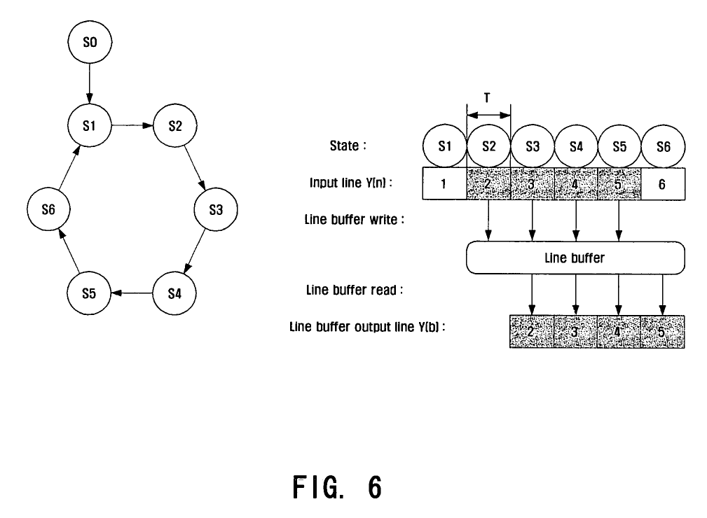

As shown in FIG. 6, the controller 100 includes 6 simple state machines, and creates control signals C1, C2 and C3 according to states of the state machines.

In response to the control signal C1, the line buffer controller 102 determines whether to store the current input line Y(n) as the selected input line Y(b-1) in the line buffer 104 and the line buffer controller 106 determines whether to read the line buffer output line Y(b) to be vertically filtered.

FIG. 6 illustrates the state machines of the controller 100 and a read/write operation of the line buffer 104 according to a state in accordance with the present invention. As shown in FIG. 6, Lines 2, 3, 4, and 5 serving as input lines Y(n) are stored as selected input lines Y(b-1) in the line buffer 104 in states S2, S3, S4, and S5 in response to the control signal C1, respectively. On the other hand, Lines 2, 3, 4, and 5 serving as line buffer output lines Y(b) are read from the line buffer 104 in states S3, S4, S5, and S6 in response to the control signal C1, such that a result of the reading operation is sent to the vertical filter 110. As compared with conventional buffer use according to the prior art, buffer use in accordance with the present invention eliminates two write operations and two read operations, thereby reducing power consumption.

The control signal C2 selects, from the coefficient set 108, a weight coefficient α by which the current input line Y(n) is multiplied and a weight coefficient 1-α by which the line buffer output line Y(b) is multiplied.

The control signal C3 controls the multiplexer 112 for outputting the new line X(m) by selecting one of the current input line Y(n) and the filtered line F(n) based on the vertical filtering.

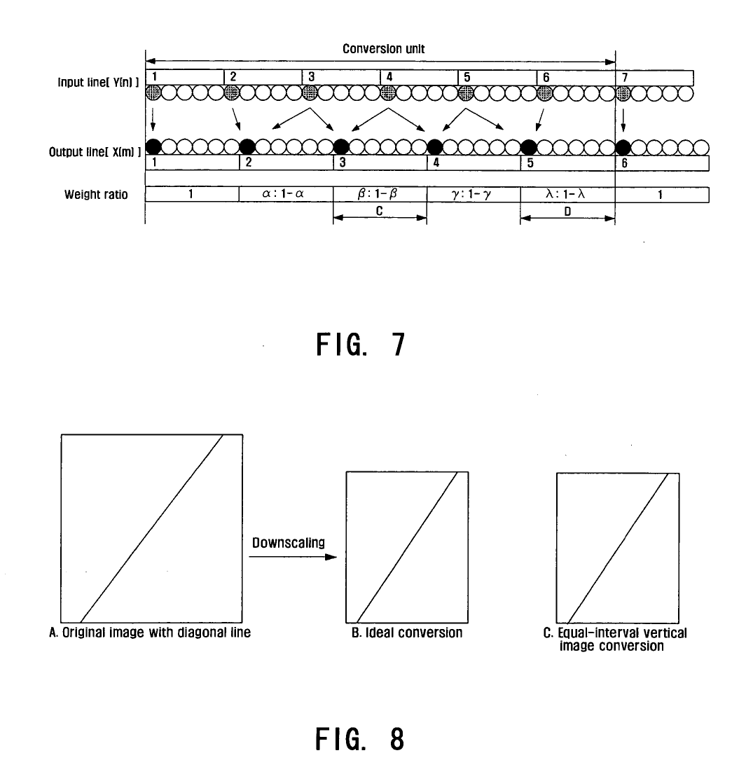

FIG. 7 illustrates a new equal-interval vertical image conversion process for equalizing spatial distances between output lines X(m) when 288 vertical lines of a CIF (Common Intermediate Format) image are converted into 240 vertical lines of an NTSC (National Television Standards Committee) image.

A weight coefficient set for equalizing intervals between the output lines X(m,m+1,m+2,Λ) is {1:0, 4/5:1/5, 3/5:2/5, 2/5:3/5, 1/5:4/5}. When 6 input lines are converted into 5 output lines, the weight coefficient set is used. The equal-interval vertical image conversion using a corrected downscaling concept is carried out on the basis of 6 input lines.

Step 1. Output Line 1 equal to Input Line 1 is outputted at a ratio of 1:0

Step 2. Output Line 2 is produced when spatial distances (at a ratio of 4/5:1/5) with Input Lines 2 and 3 are calculated and a filtering value is outputted.

Step 3. Output Line 3 is produced when spatial distances (at a ratio of 3/5:2/5) with Input Lines 3 and 4 are calculated and a filtering value is outputted.

Step 4. Output Line 4 is produced when spatial distances (at a ratio of 2/5:3/5) with Input Lines 4 and 5 are calculated and a filtering value is outputted.

Step 5. Output Line 5 is produced when spatial distances (at a ratio of 1/5:4/5) with Input Lines 5 and 6 are calculated and a filtering value is outputted.

Until 240 lines of the NTSC image are produced, the above Steps 1 to 5 are iterated.

A spatial distance between Output Lines 5 and 6 is different from a spatial distance between other output lines in the prior art. However, it can be seen that a spatial distance D between Output Lines 5 and 6 generated by the above-described process is equal to a spatial distance (e.g., C) between other output lines. A new equal-interval vertical image conversion system in accordance with the present invention can obtain the same high-quality image as when an ideal conversion filter shown in FIG. 8 is used, by eliminating the staircase effect between Output Lines 5k and 5k+1 (where k=1, 2, 3, . . . , 48) in the prior art shown in FIG. 4.

The conventional vertical image conversion circuit cannot obtain a high-quality image when converting a CIF image into an NTSC image because a spatial distance between Output Lines 5k and 5k+1 is different from a spatial distance between other output lines. However, when converting a CIF image into an NTSC image, the equal-interval vertical image conversion method and apparatus in accordance with the present invention can obtain a high-quality image in which spatial distances between all output lines X(m) are the same as each other, using a corrected weight coefficient set of {1:0, 4/5:1/5, 3/5:2/5, 2/5:3/5, 1/5:4/5} for making all spatial distances equal to each other and a corrected vertical image conversion circuit. Moreover, the equal-interval vertical image conversion method and apparatus in accordance with the present invention can reduce the overall power consumption of a vertical image conversion system by reducing the number of operations that input lines Y(n) are read from or written to the line buffer.

As apparent from the above description, the equal-interval vertical image conversion method and apparatus can be designed such that it exhibits low power consumption while requiring the same processing speed and hardware size as in the prior art. Moreover, the equal-interval vertical image conversion method and apparatus can obtain a high-quality image by eliminating the staircase effect from an image.

The present invention is appropriate for use in low-power real-time systems such as in a videophone or video conferencing to which an NTSC (National Television Standards Committee) system is applied.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An equal-interval vertical image conversion method for converting a CIF (Common Intermediate Format) image into an NTSC (National Television Standards Committee) image, comprising:
storing at least one input line (Y(n)) in a line buffer;
reading at least one output line (Y(b)) from the line buffer;
extracting coefficients to be applied to the at least one input line (Y(n)) and the at least one output line (Y(b)) from a weight coefficient set;
producing at least one filtered line (F(n)) by means of a filtering operation for applying the extracted coefficients to the at least one input line (Y(n)) and the at least one output line (Y(b)); and
outputting at least one new line (X(m)) by multiplexing the at least one input line (Y(n)) and the at least one filtered line (F(n)).

2. The equal-interval vertical image conversion method of claim 1, wherein the at least one input line (Y(n)) is selectively stored in the line buffer and wherein the at least one output line (Y(b)) is selectively read from the line buffer.

3. The equal-interval vertical image conversion method of claim 1, wherein 5 new lines (X(m)) are generated from 6 input lines (Y(n)).

4. The equal-interval vertical image conversion method of claim 2, wherein 5 new lines (X(m)) are generated from 6 input lines (Y(n)).

5. The equal-interval vertical image conversion method of claim 3, wherein ratios of weight coefficients by which the at least one input line (Y(n)) and the at least one output line (Y(b)) are multiplied are {1:0, 4/5:1/5, 3/5:2/5, 2/5:3/5, 1/5:4/5} in the weight coefficient set.

6. An equal-interval vertical image conversion apparatus for converting a CIF (Common Intermediate Format) image into an NTSC (National Television Standards Committee) image, comprising:
line buffer controllers provided before and after a line buffer for controlling read and write operations of the line buffer;
the line buffer arranged between the line buffer controllers for storing at least one selected input line (Y(b-1)) of at least one input line (Y(n)) in response to a read and write control signal (C1);
a coefficient set for storing weight coefficients by which the at least one input line (Y(n)) and at least one line buffer output line (Y(b)) are multiplied;
a vertical filter for generating at least one filtered line (F(n)) from the at least one input line (Y(n)) and the at least one line buffer output line (Y(b));
a multiplexer for outputting at least one new line X(m) by multiplexing the at least one input line (Y(n)) and the at least one filtered line (F(n)); and
a controller for outputting the write and read control signal (C1) to the line buffer controllers, outputting a control signal (C2) for selecting the weight coefficients by which the at least one input line (Y(n)) and the at least one line buffer output line (Y(b)) are multiplexed, and outputting a control signal (C3) for controlling the multiplexer.

7. The equal-interval vertical image conversion apparatus of claim 6, wherein the vertical filter comprises:
multipliers for multiplying the at least one input line (Y(n)) and the at least one line buffer output line (Y(b)) by the weight coefficients; and
an adder for summing outputs of the multipliers to generate the at least one filtered line (F(n)).
